(19) United States
(12) Patent Application Publication
(10) Pub. No.: US 2018/0267998 A1
(43) Pub. Date: Sep. 20, 2018

(54) CONTEXTUAL AND COGNITIVE METADATA FOR SHARED PHOTOGRAPHS

(71) Applicant: International Business Machines Corporation, Armonk, NY (US)

(72) Inventors: Shadi E. Albouyeh, Raleigh, NC (US); Jonathan Dunne, Dungarvan (IE); Jeremy A. Greenberger, Raleigh, NC (US); Zachary M. Greenberger, Raleigh, NC (US)

(21) Appl. No.: 15/848,360

(22) Filed: Dec. 20, 2017

Related U.S. Application Data
(63) Continuation of application No. 15/463,407, filed on Mar. 20, 2017.

(51) Int. Cl. G06F 17/30

(52) U.S. Cl. CPC G06F 17/30268

(57) ABSTRACT

A method of determining contextual and cognitive metadata for shared photographs in which a sender's device takes a photographic image, and stores the image in a file along with metadata associated with the sender. The file, with the image and metadata, is sent to a recipient's device, which receives and stores the file. The recipient's device gathers information about the recipient, and converts the information into tags. The recipient's device performs binary regression the tags in the metadata about the sender and the metadata about the recipient, and derives a context value (iContext) for the metadata tags. The context values for the sender and recipient tags are compared to determine a disposition for the related sender and recipient tags. The recipient device modifies the metadata in the file in accordance with the disposition; and stores the file with the image and the modified metadata.

### BACKGROUND

The present invention relates to photography, and more specifically to specification of metadata associated with shared photographic images.

In today's world where there is an ever increasing level of data, being able to surface relevant information is key. Ideally, information should be surfaced based on context and in fact the adage “It's all about the context” has never been more true. Today, when photo metadata is generated on a device, it's generated based on the context of the photographer, thus when the photo is shared, it carries with it this same metadata resulting in storing of non-relevant photo information on a client's device.

The ability to gather relevant metadata for the photographer or production of tags based on the information gathered, is known in prior art. For example, systems such as IBM Presence Insights™ system, as well as cognitive systems, currently provide the capability to produce tags i.e. determining the person's emotion in the form of Micro-Location Based Photo Metadata.

### SUMMARY

According to one embodiment of the present invention, a sender's device, such as a smartphone or tablet or digital camera or other computer device, takes a photographic image, and stores the image in a file along with metadata associated with the sender. The file, with the image and metadata, is sent to a recipient's device.

The recipient's device, which can be a smartphone or tablet or other computer device, receives the image file from the sender's device and stores it.

The recipient's device gathers information about the recipient, and converts the information into tags. The tags are stored as metadata.

The recipient's device performs binary regression the tags in the metadata about the sender and the metadata about the recipient, and derives a context value (iContext) for the metadata tags. The context values for the sender and recipient tags are compared to determine a disposition for the related sender and recipient tags. The dispositions can be merging the metadata (that is, storing both sender and recipient information), ignoring or removing tags, or replacing sender data with the corresponding recipient data.

The recipient device modifies the metadata in the file in accordance with the disposition; and stores the file with the image and the modified metadata.

### BRIEF DESCRIPTION OF THE SEVERAL VIEWS OF THE DRAWINGS

FIG. 1 depicts an exemplary diagram of a possible data processing environment in which illustrative embodiments may be implemented.

FIG. 2 depicts abstraction model layers according to an embodiment of the present invention.

FIG. 3 shows a user taking a photograph, with associated tags.

FIG. 4 shows a smartphone receiving the photograph of FIG. 3, with altered tags.

FIG. 5 shows a diagram of relationships between users of the method.

FIG. 6 shows a flowchart of the method.

### DETAILED DESCRIPTION

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

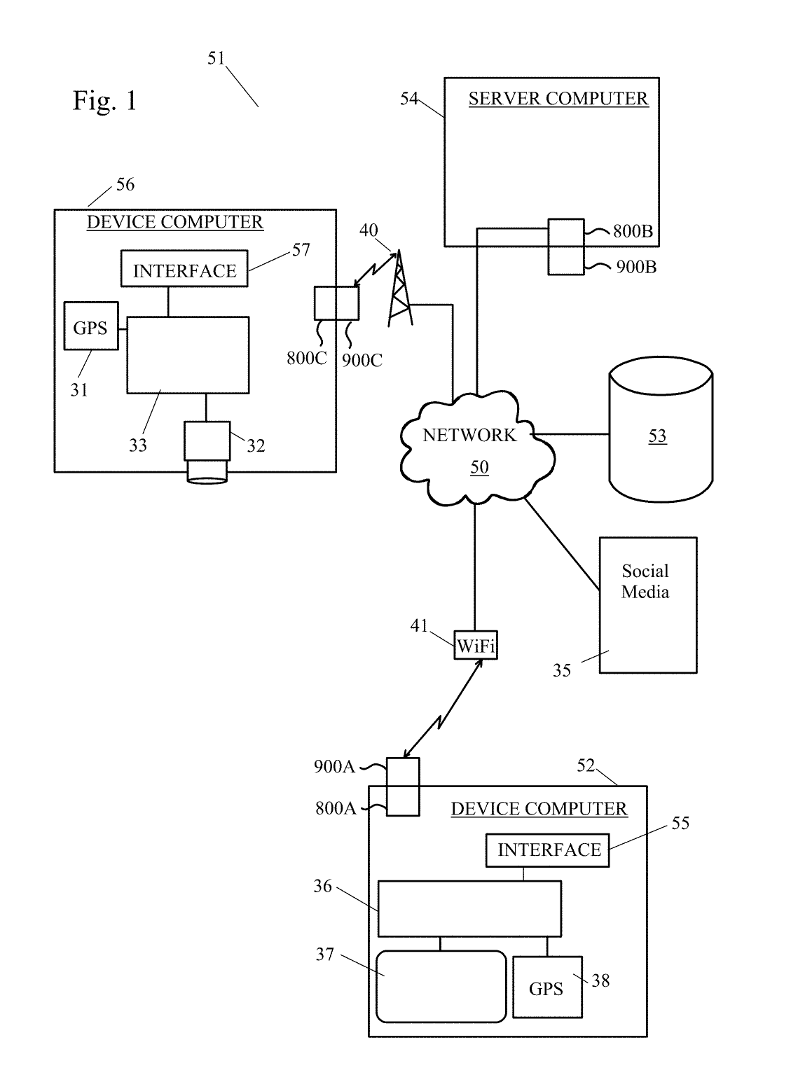

FIG. 1 is an exemplary diagram of a possible data processing environment provided in which illustrative embodiments may be implemented. It should be appreciated that FIG. 1 is only exemplary and is not intended to assert or imply any limitation with regard to the environments in which different embodiments may be implemented. Many modifications to the depicted environments may be made.

Referring to FIG. 1, network data processing system 51 is a network of computers in which illustrative embodiments may be implemented. Network data processing system 51 contains network 50, which is the medium used to provide communication links between various devices and computers connected together within network data processing system 51. In the depicted example, network data processing system 51 includes the Internet with network 50 representing a worldwide collection of networks and gateways that use the Transmission Control Protocol/Internet Protocol (TCP/IP) suite of protocols to communicate with one another. Network 50 may also include connections, such as wire, wireless communication links 41, or fiber optic cables, and in the example represents wired and wireless links such as cell phone towers 40 connected to the cell phone network. At the heart of the Internet is a backbone of high-speed data communication lines between major nodes or host computers, consisting of thousands of commercial, governmental, educational and other computer systems that route data and messages. Of course, network data processing system 51 also may be implemented as a number of different types of networks, such as, for example, an intranet, local area network (LAN), or a wide area network (WAN). FIG. 1 is intended as an example, and not as an architectural limitation, for the different illustrative embodiments.

In the depicted example, device computers 52 and 56, a repository 53, various social media servers 35 and a server computer 54 connect to network 50. In other exemplary embodiments, network data processing system 51 may include additional client or device computers, storage devices or repositories, server computers, and other devices not shown.

Device computer 52, which may be a smartphone or tablet or laptop or desktop computer, may contain an interface 55, which may accept commands and data entry from a user. The interface can be, for example, a command line interface, a graphical user interface (GUI), a natural user interface (NUI) or a touch user interface (TUI). Device computer 52 preferably has a photographic display 37 and a GPS 38 or other means for determining the geographic location of the computer 52. The device computer 52 preferably includes image processing and communication program 36. While not shown, it may be desirable to have the program 36 be present on the server computer 54. The device computer 52 includes a set of internal components 800a and a set of external components 900a. In the example of FIG. 1, device computer 52 communicates with the network 50 through a wireless (WiFi) node 41, as will be explained in greater detail below.

Device computer 56, which may be a smartphone or tablet or laptop or desktop computer, may contain an interface 57, which may accept commands and data entry from a user. The interface can be, for example, a command line interface, a graphical user interface (GUI), a natural user interface (NUI) or a touch user interface (TUI). Device computer 56 preferably has a camera 32 and a GPS 31 or other means for determining the geographic location of the computer 56. The device computer 56 preferably includes image processing and communication program 33. While not shown, it may be desirable to have the program 33 be present on the server computer 54. The device computer 56 includes a set of internal components 800c and a set of external components 900c. In the example of FIG. 1, device computer 56 communicates with the network 50 through a cellular connection to cell-phone tower 40, as will be explained in greater detail below.

Server computer 54 includes a set of internal components 800b and a set of external components 900b illustrated in FIG. 1. In the depicted example, server computer 54 can provides information, such as boot files, operating system images, and applications to the device computers 52 and 56. Server computer 54 can also communicate with social media 35 and data stored in repository 53 in order to store and retrieve information regarding the users of the device computers 52 and 56, as will be explained in greater detail below. Server computer 54 can compute the information locally or extract the information from other computers on network 50. The server computer 54 may contain one or both of the image processing and communication programs 33 or 36.

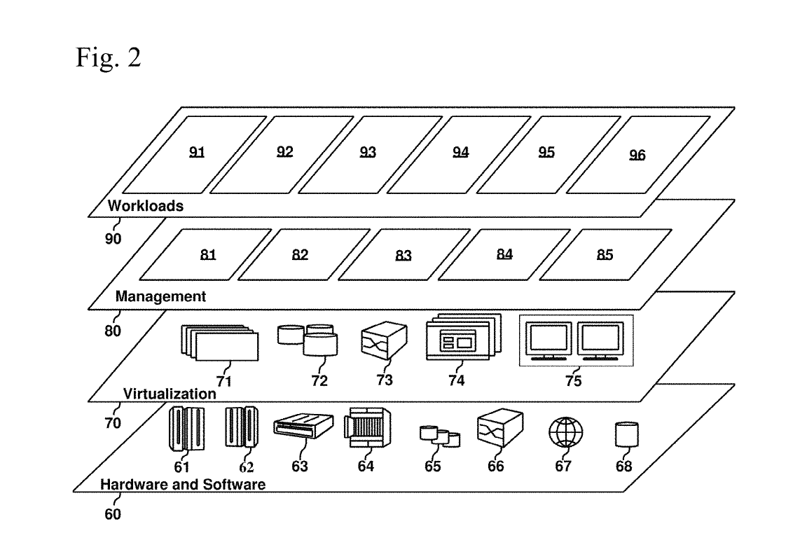

Referring now to FIG. 2, a set of functional abstraction layers provided by cloud computing environment 50 (FIG. 1) is shown. It should be understood in advance that the components, layers, and functions shown in FIG. 2 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and image processing and metadata analysis 96.

In today's world where there is an ever increasing level of data, being able to surface relevant information is key. Ideally, information should be surfaced based on context and in fact the adage “It's all about the context” has never been truer.

Today, when photo metadata is generated on a device, it's generated based on the context of the photographer, thus when the photo is shared, it carries with it this same metadata resulting in storing of non-relevant photo information on a client's device.

Existing art falls short in this particular space, only providing metadata standards versus customized contextual information relevant to all individuals involved in the viewing of images, thus this invention provides a method to contextually and cognitively transform metadata from shared photos to reflect the context of the receiver, improving the relevancy at a given point in time.

An additional embodiment to this is to use the metadata and derived context as part of an ACL type structure depending on the relationship between the individuals involved in the sharing of the images so for instance, only close friends and family may receive a specific context while a more general context is available to distant “social” friends/work colleagues.

At a high level, the invention augments the standard tags for a photo at the sender device that are particular to the intended recipient of the photo, based on social history between the sender and recipient. At the recipient's device, a similar tag augmentation process occurs. Correlation values between the sender tags and the recipient-added tags are determined and stored. When the recipient performs a search, which results are returned is based in part on the correlation values.

The following discussion will present an example of the system in use, with reference to FIGS. 1 through 5.

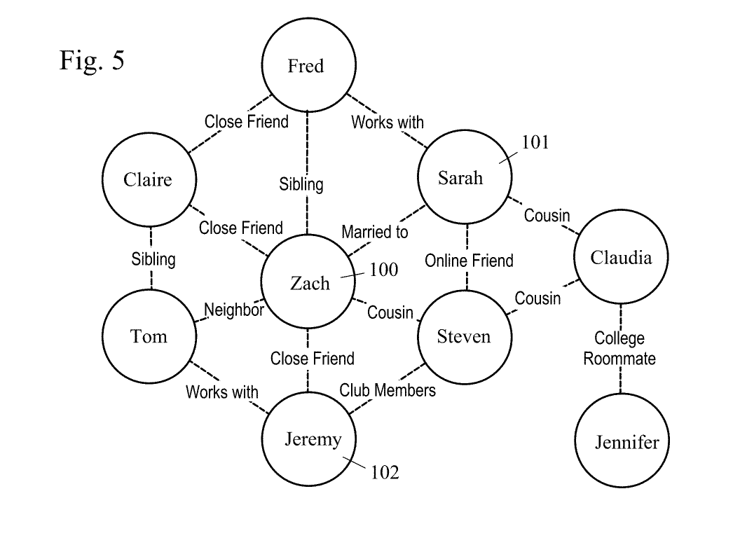

As shown in the FIG. 5, in the following example the photographer Zach 100 has connections to a number of other people. Zach 100 and Jeremy 102 are close friends, and Zach 100 is married to Sarah 101. Other people are associated with Zach 100, such as his friend Claire and his neighbor Tom, and some are relatives such as his brother Fred and his cousin Steven. These people are connected to each other in various ways—for example, Fred and Claire are friends, Steven and Jeremy are members of the local photography club, Sarah works with Fred, and Claudia is a cousin of both Sarah and Steven. Jennifer was Claudia's college roommate, but she does not know any of the others. The various relationships are recorded, for example in a repository 53 or in social media 35. The information about the relationships may also be stored locally, for example in storage on device computer 56 (which corresponds to Zach's camera 46) or device computer 52 (which corresponds to Jeremy's phone 106).

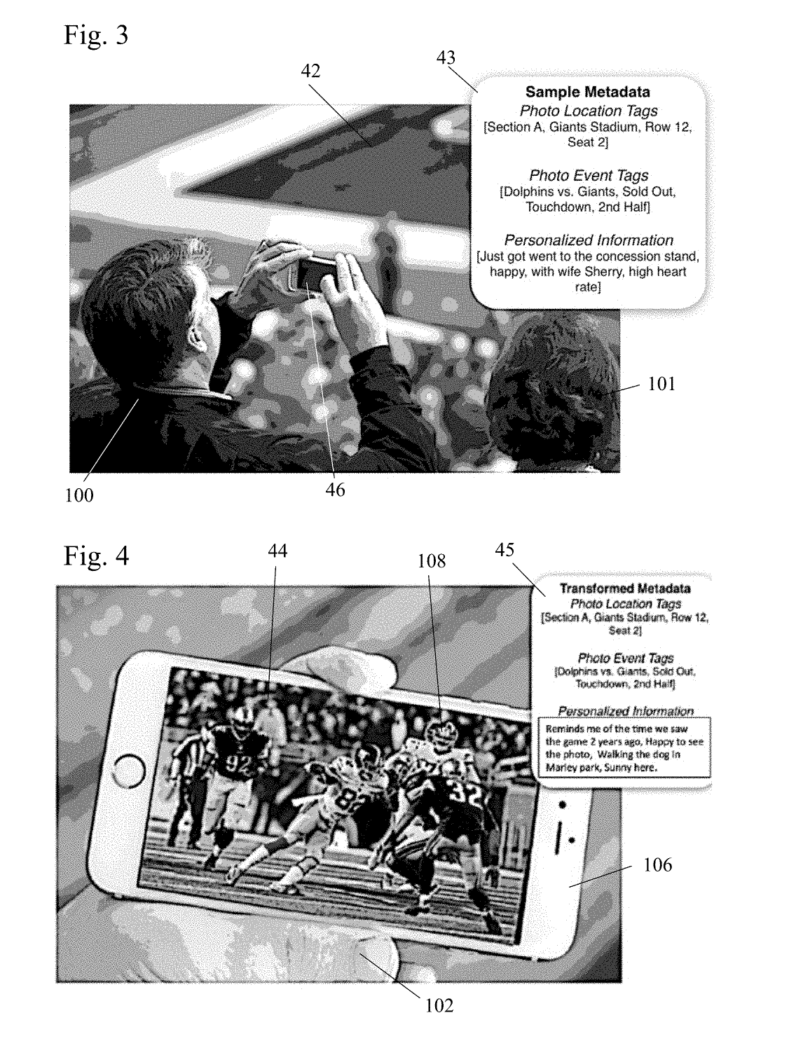

As shown in FIGS. 3 and 4, on a given day, Zach 100 and his wife Sarah 101 are attending a football game 42 at the Giants Stadium in which the Giants and Dolphins are playing. He is sitting in Section A, Row 12, Seat 2. Zach's team scores a touchdown, and Zach captures a picture 44 of the players 108 on his photographic device 46—in this example, a smartphone. Zach 100 wants to share the picture 104 with Jeremy 102.

The image processing program 33 running on Zach's smartphone 46 captures the information from the photo 104, and generates certain metadata 43 to be stored in the image file based on the current activity and status of the individual (Zach 100) taking the photo 104:

The metadata 43 might include, for example, the information indicated in Table 1. It will be understood that the example metadata are presented purely for example purposes, and other or additional metadata might be expected to be included in a real-world image file.

TABLE 1
Photo metadata for image on photographer's device

| | |
|---|---|
| Image Tags | Device: Apple iPhone |
| (i.e. EXIF, IPTC) | Exposure: 1/1000 sec @ f/5.6 |
| | Photographer: Zachary Taylor |
| | E-mail: ztaylor1849@htva.net |
| | Copyright: 2016 Z Taylor |
| Photo Location Tags | In East Rutherford, New Jersey |
| | GPS: 40.813279, −74.074274 |
| | In Giants Stadium |
| | Section A |
| | Row 12 |
| | Seat 2 |
| Photo Event Tags | Dolphins vs Giants |
| | Sold Out |
| | Touchdown |
| | Second half |
| Personalized Information | Just went to the concession stand |
| Tags | Happy |
| | With wife Sherry |
| | High heart rate |

Some of the metadata, for example the image tags, are derived from the camera settings, as is known to the art. The EXIF (EXchangeable Image File) metadata standard from the Japan Electronic Industries Development Association and the IPTC metadata standard from the International Press Telecommunications Council, for example, are standards for metadata tags and formatting defined by industry standard committees for use in storing metadata common to various photographic markets.

Other metadata, for example the Photo Location tags, are derived from location-based technology on the device, for example a GPS receiver as is commonly included in many cameras and smartphones.

Some of the metadata, for example the Photo Event tags, can be derived from specific input by the user, for example prompted by questions from the camera application, or they can be discovered by the application using the location of the camera and other information and accessing social networking or news sources online when the photo is taken.

The Personalized Information tags can be derived from difference sources in ways which are known to the art.

For example, the tag “Just went to the concession stand” in the example, can be determined from a history of what locations the device has been in over time. The device can be instructed to store location data over a defined period of time, for example through a settings screen in a camera application, in order to create such metadata. The camera application could choose to include multiple prior locations as tags, or could select locations based on importance determined, for example, through social media or user entry. Alternatively, the camera application could store and/or tag images with prior locations based on how long the device had remained in the location—for example, the camera application could be instructed to store any location in which the device had remained for more than half an hour, and to retain that information and insert it as a tag for the next three hours.

Tags relating to emotional state, such as “Happy”, can be determined through the use of facial recognition software accessing a rearward-facing camera to image the user of the device when the picture was taken. The image of the user can be processed to extract facial features. Such a method is shown in “How to set up Face Unlock on your Android Phone”, posted by Gary Mazo on the androidcentral.com website on Jul. 24, 2012. From the facial features, one can make an estimation of how the user is feeling, as is shown in an article entitled “20+ Emotion Recognition APIs That Will Leave You Impressed, and Concerned” posted by Bill Doerrfeld on the nordicapis.com website on Dec. 31, 2015. Alternatively, this tag could be created based on a user input, perhaps in response to a prompt from the camera application.

Tags relating to other people in close proximity, such as the tag “with wife Sherry” in the example above, could be derived from information provided by applications running on the device, for example the “Find Friends” app provided on Apple iPhones. Alternatively, this information could be derived from the device receiving transmissions from nearby devices, for example by Bluetooth® or Wi-Fi or other radio-frequency systems.

Tags relating to physical characteristics, for example the “High heart rate” tag in the example above, can be detected by readings from various forms of smart wearable devices such as one of the many “smart watches” available from Apple Corporation or Garmin or other manufacturers, or a device such as the FitBit® activity tracker from FitBit, Inc. Alternatively, the information could be derived from readings of internal sensors in the device, for example accelerometers measuring vibration, or from other sources.

The particular tags to be included in the metadata for an image will preferably be preset before the picture is taken. It will be understood that there is a huge range of data which could be included in the tags within the teaching of this disclosure, and the tags shown in the examples are not intended to limit the scope of the metadata which might be used in connection with the present system. The selection of which tags are used at any given time could be specified by the user of the device through settings in the camera application program, either by opting-out of a default list, or by picking tags from a provided list. The more data which is collected, the higher fidelity results.

Zach instructs his smartphone 46 to send the photo 104 to his close friend Jeremy 102. The smartphone uploads the image file containing the picture 104 and the metadata 43 through a nearby cell tower 40 to the network, addressed to Jeremy 102, for example by SMS message, or e-mail, or Skype or FaceTime, or in any other way known to the art. This transmission may include server computer 54 which may be a Skype or FaceTime server, or an e-mail server at Jeremy's Internet Service Provider (ISP), or some other system by which image files might be transferred.

Meanwhile, Jeremy 102 is doing some shopping at the Best Buy store near his home in Paramus, N.J. The Best Buy store provides a WiFi access node 41, through which Jeremy's smartphone 106 (device computer 52) is connected to the Internet (network 50).

Jeremy's smartphone 106 receives the image file containing the photo 104 and metadata 43, for example from server computer 54 through network 50 and WiFi access node 41.

The camera application on Jeremy's smartphone 106 can be programmed to gather information for metadata tags, similarly to Zach's phone 46, as explained above. For example, Jeremy might have been presented with a default list of tags as part of setting up the camera application on his smartphone, and he might have opted out of some tags, for example barometric pressure, but left other tags, for example blood pressure from a smart watch device, checked for inclusion with images. The information selected by Jeremy is accumulated in the memory of his smartphone, ready for use in the method.

During this process, the program 36 on Jeremy's smartphone 106 evaluates the metadata 43 in image file with the photo 104, and during this process, determines if a particular item of metadata 43 is based on the photographer or on the photo. If a particular item of the metadata 43 is about the photo 104, the program 36 retains the information without modification. For example, this might be the image tags in table 1, above.

If the item of metadata 43 is related to the photographer, the program 36 transforms the item of metadata by merging or augmenting it with the receiver's information. (e.g. personalized information) to produce transformed metadata 45.

The metadata 43 is analyzed and transformed into transformed metadata 45 to reflect the following, making it more relevant to Jeremy given his current situation:

TABLE 2
Transformed photo metadata for image on receiver's device

| | |
|---|---|
| Image Tags (EXIF, IPTC) | Device: Apple iPhone |
| | Exposure: 1/1000 sec @ f/5.6 |
| | Photographer: Zachary Taylor |
| | E-mail: ztaylor1849@htva.net |
| | Copyright: 2016 |
| Photo Location Tags | Giants Stadium |
| | Section A, Row 12, Seat 2 |
| Photo Event Tags | Dolphins vs Giants |
| | Sold Out |
| | Touchdown |
| | Second half |
| Personalized information | Just left the supermarket |
| pertaining to sender | In Best Buy Store |
| | In Paramus, New Jersey |
| | Happy |
| | Normal Blood Pressure |
| | 75 degrees outside |
| | GPS: 40.914856, −74.075491 |
| Personalized information | Reminds me of the time we saw the game |
| pertaining to recipient | 2 years ago |
| | Happy to see the photo |
| | Sunny here |

The transformed metadata allows Jeremy 102 to search his phone 106 for photos with metadata associated with when he received/saved the image.

For example, Jeremy can search his phone for “the image that I got from Zach of the football game when I was in the Paramus Best Buy and had just left the supermarket” in order to easily retrieve the photo he had in mind via the transformed metadata information 45.

The program 36 on Jeremy's smartphone 106 analyzes the metadata (context tags) 43 transmitted with the image 104, as merged with Jeremy's metadata, in order to derive a contextual co-efficient, hereinafter referred to as “iContext”, for example by program 36. This provides the ability to associate an emotion to an image, analogous to how someone feels and what they remember when they hear a particular song, taking them back in time.

The iContext data is attached to the image file containing the transformed metadata 45 and image 104, and the image file with the transformed metadata 45 and iContext data is then saved locally on the Jeremy's smartphone 106.

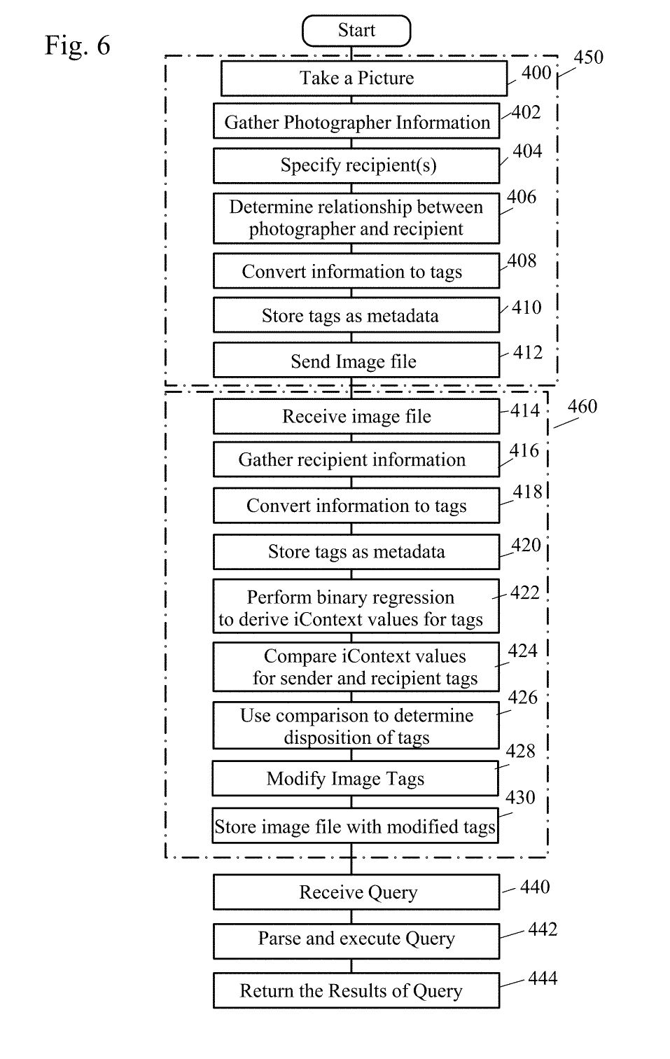

Referring to the flowchart of FIG. 6, the method can be summarized as:

Steps 400 through 412 take place on the photographer's device 450.

Step 400: The photographer takes a picture.

Step 402: The photographer's device gathers photographer information. This could include the standard information, for example as specified in standards such as the EXchangeable Image File (EXIF) format or the format specified by the International Press Telecommunications Council (IPTC). Manufacturer-specific information can also be included, such as make, model and software version for the image-taking device (camera or smartphone, for example).

In addition, information can be derived from the subject of the photo, such as place, activity, or identity derived from facial recognition.

Additional information regarding the social activity context of the photo can be derived from external sources, for example, information derived from messages sent or received by the photographer; information derived from, for example, news feeds (e.g. what teams are playing, that a touchdown just occurred, etc.) or social media (photographer's current status, etc.); information pertaining to environmental context, such as temperature, weather conditions, etc.; and personal context information, such as heart rate; etc.

Step 404: The photographer specifies one or more recipients for the photo.

Step 406: The photographer's device determines the relationship between the photographer (sender) and the recipient. For example, a relationship could be as shown in FIG. 5 and discussed above—a family relationship such as parent or sibling or cousin or distant relative, close friend, casual friend, work colleague. The device could also determine a level of sharing or tone of interaction, etc., between the sender and the recipient, based on social media and other information of the sender. This can be used to determine level of sharing of info, i.e., what tags will be added at the recipient side.

Step 408: The photographer's device converts all the information into tags—e.g., within predefined dimensions, such as time, place, event, social media context, environmental, relationship to recipient, other, etc.

Step 410: The tags are stored as metadata in the image file containing the photograph, for example as tag/value pairs as shown in the tables above.

Step 412: The photographer's device sends the image file containing the photo and metadata to the recipient(s).

Steps 414 through 430 occur on the recipient's device 460. It will be understood that from this point on, the method is described in terms of processing by a single recipient's device. If the image was sent to more than one recipient, each recipient's device performs the following steps independently of the other recipients, so that the result of the method will differ from recipient to recipient.

Step 414: A recipient's device, for example a smartphone or a tablet or some other computer device, receives the image file containing the photograph and metadata.

Step 416: The recipient's device gathers receiver information. This step is similar to step 402, but based on the information pertinent to the recipient rather than the sender. The information may include information about what the recipient is doing, where the recipient is located, where the recipient has been recently, etc.

Additional information regarding the social activity context of the recipient at the time of receipt of the image file can be derived from external sources, for example, information derived from messages sent or received by the recipient; information derived from, for example, news feeds (e.g. what is going on in the world or near the recipient, etc.) or social media (e.g. recipient's status, etc.); information pertaining to environmental context, such as temperature, weather conditions, etc.; and personal context information, such as heart rate; etc.

The information gathered may be related to information in the metadata in the image—for example, if the event tag includes “football game”, the recipient's device may gather data related to the recipient's activities involving football games, for example by searching messages or posts to social media.

Step 418: The recipient's device converts the recipient information into tags.

Step 420: The recipient's device stores the recipient information tags and the values which correspond to the tags on the recipient's device, for example as tag/value pairs as shown in the tables above.

Step 422: The recipient's device performs binary regression to determine association of the multi-factor analysis and derive an iContext value for tags in the sender's and recipient's information. The iContext value can be derived for all tags, or for a selection of tags, within the teachings of the method.

The iContext quotient computation determines numerically the relationship between sender and receiver tags, and derives an iContext value in a range between 0 and 1. The iContext value can then be used as a guide for data transformation.

The following is a representative example of how an iContext quotient might be computed.

The tags used in the example are summarized in Table 3, below. The tag values in Table 3 are from the metadata in the image file as received. The initial relevance scores could be derived from an entity/summarization system. For example Watson Alchemy API from IBM allows a user to enter text and entity, summarization, emotional analysis can be inferred, and a relevance score attached.

TABLE 3
Sender Tags for iContext Calculation Example

| Tag | Value | Relevance |
|---|---|---|
| Photo taker | Zach | |
| Photo recipient | Jeremy | |
| Event | Dolphins vs Giants | |
| Photo Location1 | Giants Stadium | 0.789 |
| Photo Location2 | Section A, Row 12, Seat 2 | 0.899 |
| Event Tag1 | Dolphins vs Giants | 0.788 |
| Event Tag2 | Sold Out | 0.812 |
| Event Tag3 | Touchdown | 0.457 |
| Event Tag4 | 3rd Quarter | 0.562 |

To determine overall tag relevancy, we can use a logistic regression model to perform the analysis. Note in this simple example below our final model below does not require all relevancy parameters to produce a final model. In this example four parameters are chosen to be the most useful in determining relevancy

In order to build a regression model you need to use the values in the estimates column along with the actual values used in the row data to compute a prediction. The variables are listed in the parameter column, the values of the parameters are the estimates values.

For this we can use a logistic regression model like so

TABLE 4
Parameters in regression analysis

| | | | | | antilog of |
|---|---|---|---|---|---|
| Parameter | estimate | s.e. | t(*) | t pr. | estimate |
| Constant | 2.22 | 2.20 | 10.12 | <.001 | 4478578096. |
| PL_relevance1 | −0.005 | 1.05 | −9.94 | <.001 | 0.00002887 |
| PL_relevance2 | 0.14 | 0.46 | 0.54 | <.001 | 0.36237263 |
| ET_relevance1 | 0.6 | 0.96 | 1.05 | <.001 | 0.67893439 |
| ET_relevance2 | 0.2 | 0.54 | 0.76 | <.001 | 0.65895439 |

In the above table, s.e is the Standard Error—a measure of the accuracy of predictions. Recall that the regression line is the line that minimizes the sum of squared deviations of prediction (also called the sum of squares error). T(*) is the estimate of variance from a t-statistic. T pr, is the statistical significance. The lower the value for each estimate the better each parameter fits the model. A rule of thumb a value of less than 0.05 shows a strong correlation/regression effect.

Using the estimates we have a fitted regression line as follows:

log(p/1−p)=0.22−0.005PL_relevance1+0.014PL_relevance2+0.6ET_relevance1+0.2ET_relevance2

We insert the observed values for each parameter i.e.
PL_relevance1=0.798
PL_relevance2=0.899
ET_relevance1=0.788
ET_relevance2=0.812

So with the estimated parameter and the observed values multiplied out. We therefore calculate:

log(p/1−p)=0.22−(0.005*0.789)+(0.14*0.899)+(0.6*0.788)+(0.2*0.812)

log(p/1−p)=0.977

p/(1−p)=ê0.977

p=2.65/(1+2.65)
p=0.72
iContext=0.72

The same approach (logistic regression modelling) can be undertaken for recipient tag data. The regression modelling for these tags is not shown.

Step 424: The iContext values can then be used to guide contextual inference of the based on the tuple of the photo taker and the receiver. This is done by comparing the iContext values for the sender and receiver images.

Step 426: Use the comparison of the iContext values to determine the disposition of the tags—that is, which tags are to be kept, merged, ignored or replaced in the image file.

The following is a mapping table demonstrating what can be done once the iContext values are computed from both sides:

TABLE 4
Use of iContext Values

| | | 0 ← Sender iContext Value → 1 | | |
|---|---|---|---|---|
| 0 | Receiver | MERGE | Remove Tag | Remove Tag |
| ↑ | iContext | Replace Tag | MERGE | Remove Tag |
| ↓ | Value | Replace Tag | Replace Tag | MERGE |
| 1 | | | | |

“Remove Tag” may be labeled “Ignore Tag” depending on how strict we want the final tags on the image. “MERGE” allows the final tags on the image to contain BOTH tags from the sender and receiver on the final image.

Step 428: Modify the tags in the image in accordance with the actions determined in step 432.

Step 430: Store the image file with the modified tags. The image file may be stored on one or more of the recipient's device, a remote server, or a home computer or backup disk.

The following steps might be performed on the recipient's device, or on some other device onto which the image file was downloaded or to which it was sent by the recipient.

Step 440: Receive Search Query: At some future time, the recipient's device (or some other device holding the image files) receives a search query to locate one or more photos which meet certain criteria relevant to the recipient.

Step 442: Parse Search Query: The search query is parsed, and based on correlations between the search terms and the tags and correlation value between the received sender tags and the generated recipient tags, the search results are returned in a prioritized order.

The priority will be dependent on the application leveraging this technology as well as user's preferences. For instance, in this example Jeremy may want to recall the image Zach sent him but doesn't remember where it is on the device, however, he does remember his location at the time of receiving it was Best Buy so his search term would be Best Buy so the mobile device would search on any tag or information that pertains to location in order to come back with a list that could be prioritized by various other parameters including but not limited to confidence rating, date, etc.

The correlation between the tags will expedite the search but this is really an association between different tag mappings to improve the retrieval of the photo.

Step 444: Return the results of the search query.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method of determining contextual and cognitive metadata for shared photographs comprising the steps of:
a) a recipient device receiving a file from a sender device, the file comprising an image and associated metadata, the metadata comprising a plurality of tags and values specifying information about the sender and the image in the file;
b) the recipient device gathering information about the recipient;
c) the recipient device converting the information about the recipient into metadata comprising a plurality of tags and values specifying information about the recipient;
d) the recipient device performing binary regression on at least one of the plurality of tags and values specifying information about the sender to derive a context value for the at least one of the plurality of tags and values specifying information about the sender;
e) the recipient device performing binary regression on at least one of the plurality of tags and values specifying information about the recipient to derive a context value for the at least one of the plurality of tags and values specifying information about the recipient;
f) the recipient device comparing the context value for the at least one of the plurality of tags and values specifying information about the sender to the context value for the at least one of the plurality of tags and values specifying information about the recipient to determine a disposition for the at least one of the plurality of tags and values specifying information about the sender and the at least one of the plurality of tags and values specifying information about the recipient;
g) the recipient device modifying the metadata in the file in accordance with the disposition; and
h) the recipient device storing the file with the image and the modified metadata.

2. The method of claim 1, in which the disposition in step f is selected from the group consisting of:
merging the at least one of the plurality of tags and values specifying information about the sender and the at least one of the plurality of tags and values specifying information about the recipient, such that after modification the metadata in the file will store both information about the sender and information about the recipient;
removing the at least one of the plurality of tags and values specifying information about the sender and the at least one of the plurality of tags and values specifying information about the recipient from the metadata; and
replacing the at least one of the plurality of tags and values specifying information about the sender with the at least one of the plurality of tags and values specifying information about the recipient.
